(19) United States
(12) Patent Application Publication
(10) Pub. No.: US 2017/0314318 A1
(43) Pub. Date: Nov. 2, 2017

(54) Door Assistance System for a Vehicle

(71) Applicant: Conti Temic microelectronic GmbH, Nuernberg (DE)

(72) Inventor: Christoph HASSENPFLUG, Lindau (DE)

(21) Appl. No.: 15/519,923

(22) PCT Filed: Nov. 10, 2015
(86) PCT No.: PCT/DE2015/200496

§ 371 Date: Apr. 18, 2017

(30) Foreign Application Priority Data
Nov. 20, 2014 (DE) 10 2014 223 742.4

(51) Int. Cl. E05F 15/73; G08G 1/16; E05F 15/40

(52) U.S. Cl. CPC E05F 15/73; G08G 1/168; E05F 15/40; E05Y 2900/531; E05F 2015/767; E05F 2015/765; E05Y 2900/546; E05Y 2900/548; E05Y 2900/536

(57) ABSTRACT

The invention relates to a door assistance system (1) for a vehicle (F) for preventing damage to vehicle doors (T1-T4) and/or vehicle opening panels (T5) caused by external objects when vehicle doors (T1-T4) and/or vehicle opening panels (T5) are opened. Said system comprises: a calculation unit (7), which evaluates an environmental data model, detected by sensors, of the surroundings of the vehicle (F), in order to determine a space around the vehicle (F) that is free of external objects (H1, H2, O), and which calculates maximum possible open positions of the various vehicle doors (T1-T4) and/or vehicle opening panels (T5) of the vehicle (F) within the free space that has been determined; and a locking unit (8), which locks a vehicle door (T1-T4) and/or vehicle opening panel (T5) of the vehicle (F) when same is opened to the correspondingly calculated maximum permissible open position of the respective vehicle door (T1-T4) and/or vehicle opening panel (T5) in order to prevent contact with an external object and/or to provide entry or exit assistance.

The invention relates to a door assistance system for a vehicle for preventing door damage to vehicle doors and/or vehicle opening panels caused by external objects when vehicle doors and/or vehicle opening panels are opened, and to facilitate entry and exit.

Conventional vehicles have several vehicle doors and vehicle opening panels. Automobiles usually have two or four vehicle doors and a trunk panel or tailgate. Most vehicles also have an engine compartment lid. In many cases, vehicles also have a sunroof on the top of the vehicle body. In conventional vehicles, which, by way of example, are parked in parking spaces, when a vehicle door or vehicle panel is opened it may happen that this hits an external object, particularly a vehicle parked alongside, causing scratches or paint damage to one or both of the vehicles.

It is therefore an object of the invention to provide a device and a method for preventing door damage to the vehicle doors and/or vehicle opening panels of the vehicle caused by external objects when the vehicle door and/or vehicle panel is/are opened.

This object is achieved according to the invention by a door assistance system with the features indicated in Claim 1.

According to this, the invention provides a door assistance system for a vehicle for preventing door damage to vehicle doors and/or vehicle opening panels caused by external objects when vehicle doors and/or vehicle opening panels are opened, having a calculation unit, which evaluates an environmental data model, detected by sensors, of the surroundings of the vehicle in order to determine a space around the vehicle that is free of external objects, and which calculates maximum open positions of the various vehicle doors and/or vehicle opening panels of the vehicle within the free space that has been determined, and a locking unit, which locks a vehicle door and/or vehicle opening panel of the vehicle when same is opened to the corresponding calculated maximum permissible open position of the respective vehicle door and/or vehicle opening panel in order to prevent contact with an external object and/or to provide entry and/or exit assistance.

The door assistance system according to the invention offers the advantage that when a vehicle door or a vehicle opening panel is opened, it is reliably locked in a maximum permissible open position, so that scratches or paint damage to the vehicle concerned or a vehicle positioned alongside it are prevented. It is also advantageous that it is not necessarily required that the opening range of a vehicle door or a vehicle opening is monitored during opening with a sensor system. The free space around the vehicle or above the vehicle, the latter being necessary for opening the tailgate, for example, can be or is determined at an earlier point in time, e.g. when passing a parking space or entering or approaching a garage or a carport. So, in the latter, for example, the height can be determined with a forward- or backward-facing sensor system, which is necessary, for example, for the opening range of the tailgate.

The door assistance system according to the invention also offers the advantage that the locked vehicle door can provide additional support to a person when entering or exiting.

In a possible embodiment of the door assistance system according to the invention, the environmental data model comprises a rasterized map of the vehicle environment.

In a further possible embodiment of the door assistance system according to the invention, the environmental data model also has a height profile of the vehicle environment.

In a further possible embodiment of the door assistance system according to the invention, the environmental data model is calculated based on sensor data, generated by vehicle sensors of the vehicle or by external sensors.

In a further possible embodiment of the door assistance system according to the invention, the vehicle sensors comprise laser scanners, radar sensors and/or vehicle cameras.

In a further possible embodiment of the door assistance system according to the invention, a current environmental data model of the vehicle environment of the vehicle is temporarily stored in a first data memory, to which the calculation unit of the door assistance system has access.

In a further possible embodiment of the door assistance system according to the invention, the calculation unit has access to a second data memory, in which vehicle data of the vehicle, particularly vehicle dimensions of the vehicle body and/or dimensions of vehicle doors and/or vehicle opening panels of the vehicle, are stored.

In a further possible embodiment of the door assistance system according to the invention, the vehicle data of the vehicle stored in the second data memory are configurable for various vehicle types and/or vehicle variants of the vehicle.

In a further possible embodiment of the door assistance system according to the invention, the calculation unit of the door assistance system calculates the maximum permissible open positions of the vehicle doors and/or vehicle opening panels of the vehicle as a function of an instantaneous loading state of the vehicle detected by sensors.

In a further possible embodiment of the door assistance system according to the invention, the door assistance system is activated automatically upon entering a parking space or once the vehicle has stopped.

In a further possible embodiment of the door assistance system according to the invention, the door assistance system is deactivated automatically once the vehicle starts up or upon leaving a parking facility or parking space.

In a further possible embodiment of the door assistance system according to the invention, the vehicle doors comprise several side doors of the vehicle and the vehicle opening panels comprise a trunk panel, a tailgate, or an engine compartment lid, of the vehicle.

According to a further aspect, the invention also provides a vehicle, particularly a road vehicle, with a door assistance system for preventing door damage to vehicle doors and/or vehicle opening panels of the vehicle caused by external objects when vehicle doors and/or vehicle opening panels are opened, wherein the door assistance system comprises a calculation unit, which evaluates an environmental data model, detected by sensors, of the surroundings of the vehicle, in order to determine a space around the vehicle that is free of external objects, and which calculates maximum permissible open positions for the various vehicle doors and/or vehicle opening panels of the vehicle within the free space that has been determined, wherein the door assistance system also comprises a locking unit, which locks a vehicle door and/or vehicle opening panel of the vehicle when same is opened to the correspondingly calculated maximum permissible open position of the respective vehicle door and/or vehicle opening panel in order to prevent contact with an external object and/or to provide entry or exit assistance to a person.

In a possible embodiment of the vehicle according to the invention the vehicle is an automobile.

In a further possible embodiment of the vehicle according to the invention the vehicle is a truck.

According to a further aspect, the invention provides a parking facility with a central control system, communicating via wireless interfaces with door assistance systems of vehicles according to the first aspect of the invention, wherein the central control system also transmits sensor data generated by sensors of the parking facility for updating the respective environmental data model to the door assistance systems of the vehicles located in the parking facility, wherein the door assistance systems of the vehicles located in the parking facility take the received sensor data of the parking facility into consideration when updating the respective environmental data model of the respective vehicle.

According to a further aspect, the invention provides a method for preventing door damage to vehicle doors and/or vehicle opening panels caused by external objects in a vehicle with the features indicated in Claim 15.

Accordingly, the invention provides a method for preventing door damage to vehicle doors and/or vehicle opening panels caused by external objects in a vehicle having the following steps:

determining a space around the vehicle that is free of external objects on the basis of a detected environmental data model and stored vehicle data of the vehicle;

calculating maximum permissible open positions of the various vehicle doors and/or vehicle opening panels of the vehicle within the free space that has been determined and locking a vehicle door and/or vehicle opening panel of the vehicle when same is opened to the calculated maximum permissible open position of the respective vehicle door and/or vehicle opening panel in order to prevent contact with an external object and/or to provide entry or exit assistance.

The invention also provides a driver assistance system for a vehicle with a control unit for performing the method according to the invention.

In the following, possible embodiments of the door assistance system according to the invention together with the method according to the invention for preventing door damage to vehicle doors and/or vehicle opening panels caused by external objects, are explained in more detail with reference to the attached figures.

These show as follows:

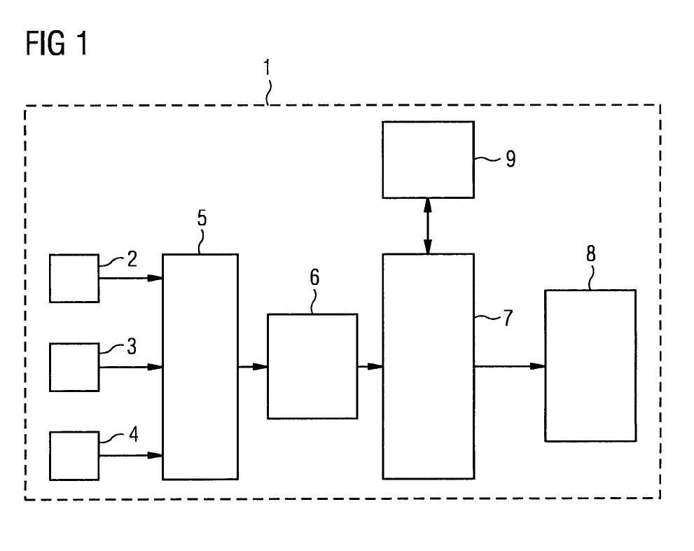

FIG. 1 a block diagram representing an exemplary embodiment of a door assistance system according to the invention for a vehicle;

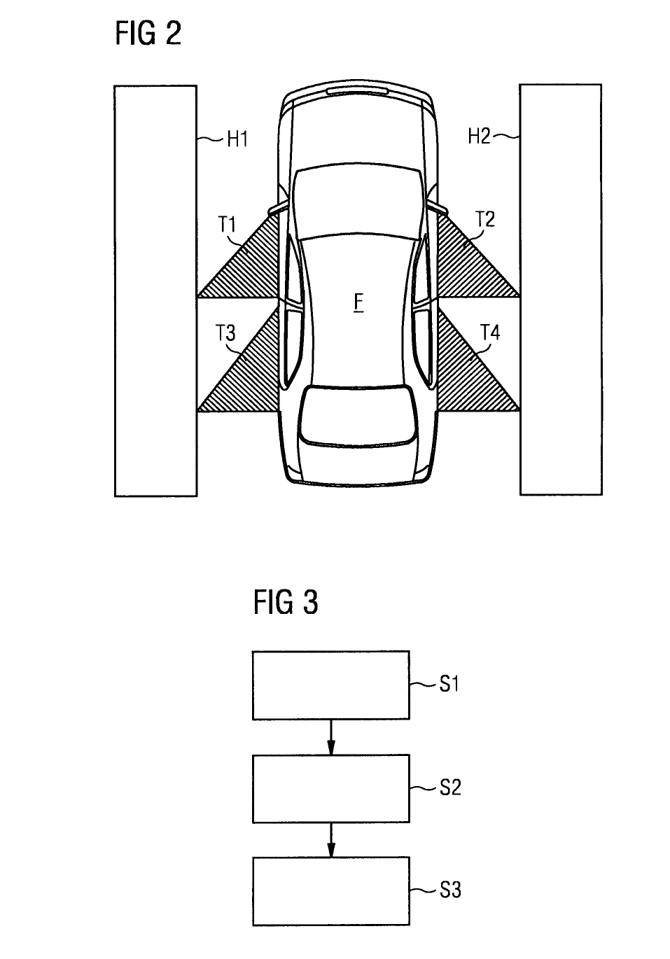

FIG. 2 a schematic representation to explain the functioning of the door assistance system according to the invention;

FIG. 3 a flow chart explaining an exemplary embodiment of a method according to the invention to prevent door damage to vehicle doors and/or vehicle opening panels;

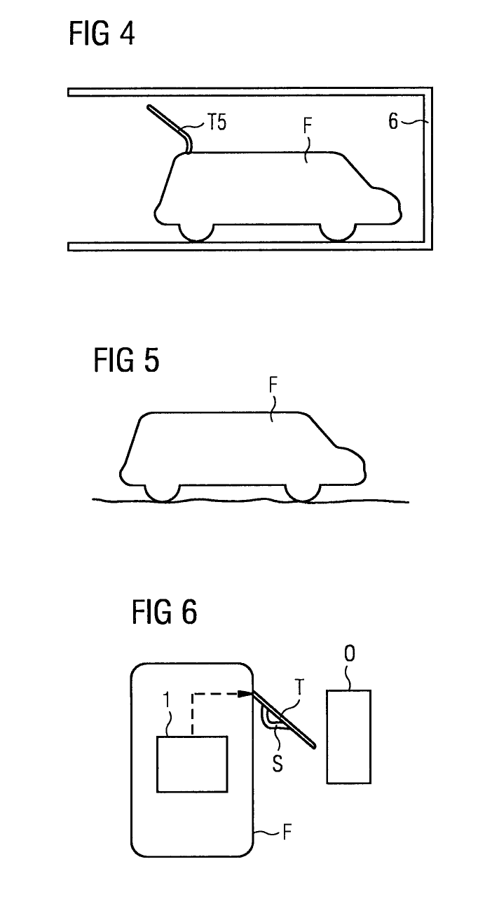

FIGS. 4, 5, 6 schematic representations to explain the functioning of the door assistance system according to the invention and of the method according to the invention.

As can be seen from FIG. 1, a door assistance system 1 according to the invention in the exemplary embodiment represented comprises various components. In the exemplary embodiment represented the door assistance system 1 has various vehicle sensors 2, 3, 4. The number and type of vehicle sensors for detecting the vehicle environment may vary. In a possible embodiment, the door assistance system 1 comprises at least one laser scanner 2, at least one radar sensor 3 and one or more vehicle cameras 4. The vehicle sensors 2, 3, 4 provide sensor data, which are evaluated by an evaluation unit 5 to determine an environmental data model. In a possible embodiment, the detected environmental data model of the vehicle environment of the vehicle F can be temporarily stored in a first data memory 6 provided for this purpose. The door assistance system 1 comprises a calculation unit 7, which is able to access the environmental data model of the vehicle environment of the vehicle F temporarily stored in the first data memory 6. The calculation unit 7 evaluates the environmental data model of the vehicle environment of the vehicle detected by sensors in order to determine a space around the vehicle F that is free of external objects and calculates maximum permissible open positions of the various vehicle doors and/or vehicle opening panels of the vehicle F within the free space that has been determined. The door assistance system 1 also has one or more locking units 8, which each lock a respective vehicle door and/or vehicle opening panel of the vehicle F when same is opened to the corresponding maximum permissible open position of the respective vehicle door and/or vehicle opening panel calculated by the calculation unit 7 in order to prevent contact with an external object.

In the exemplary embodiment shown in FIG. 1, the calculation unit 7 also has access to a second data memory 9, in which vehicle data of the vehicle F, particularly vehicle dimensions of the vehicle body and/or dimensions of vehicle doors and/or vehicle opening panels of the vehicle F, are stored. In a possible embodiment, the vehicle data of the vehicle F stored in the second data memory 9 are configurable for various vehicle types and/or vehicle variants of the vehicle F. In a possible embodiment, the calculation unit 7 of the door assistance system 1 calculates the maximum permissible open positions of the vehicle doors and/or vehicle opening panels of the vehicle F taking the vehicle data of the vehicle into consideration, particularly the stored vehicle dimensions of the vehicle body and/or the stored dimensions of the vehicle doors and/or vehicle opening panels of the vehicle F. In a further possible embodiment of the door assistance system 1 according to the invention, the calculation unit 7 of the door assistance system 1 calculates the maximum permissible open positions of the vehicle doors and/or vehicle opening panels of the vehicle F as a function of an instantaneous loading state of the vehicle F detected by sensors.

Further embodiments of the door assistance system 1 represented in FIG. 1 are possible. In a possible embodiment, the door assistance system 1 is activated automatically upon entering a parking facility or parking in a parking space or once the vehicle F has stopped. In this embodiment, the door assistance system 1 according to the invention is deactivated during normal travel of the vehicle F, since it is not expected that vehicle doors and/or vehicle opening panels will be opened while the vehicle is travelling. In this way, resources, particularly computing resources, can be saved. In a further possible embodiment of the door assistance system 1 according to the invention, the door assistance system 1 is automatically deactivated once the vehicle F starts up or leaves a parking facility or parking space. The door assistance system 1 according to the invention is suitable for locking various vehicle doors and/or vehicle opening panels of the vehicle F at a calculated maximum permissible open position. These vehicle doors comprise particularly the side doors of an automobile and vehicle opening panels, particularly a trunk panel, a tailgate or an engine compartment lid, of the vehicle F.

In a further possible embodiment of the door assistance system 1 according to the invention, the door assistance system 1 communicates via a transceiver of the vehicle F with an external control system, by way of example a central control system of a parking facility. In such a parking facility, a central control system of the parking facility can receive sensor data from sensors installed in the parking facility. These sensor data are transmitted via a wireless interface of the door assistance system 1 to the evaluation unit 5, which evaluates the received sensor data for updating the respective environmental data model of the vehicle F concerned. In this embodiment, therefore, the evaluation unit 5 of the door assistance system 1 can not only access sensor data of vehicle sensors 2, 3, 4, but can also take into consideration sensor data provided by external sensors of the parking facility. This allows refinement of the current environmental data model of the vehicle environment of the vehicle F. In a possible embodiment, the door assistance system 1 represented in FIG. 1 forms part of a driver assistance system of the vehicle F.

FIG. 2 serves to illustrate the functioning of the door assistance system 1 according to the invention. The example represented in FIG. 2 relates to an automobile with four side doors T1, T2, T3, T4. The vehicle F is parked between two obstacles H1, H2, which may similarly be parked vehicles, by way of example. Once the vehicle F has driven into the parking space between the two obstacles H1, H2, in a possible embodiment the door assistance system 1 according to the invention is automatically activated. Based on the current environmental data model of the vehicle environment of the vehicle F detected by sensors, the calculation unit 7 of the door assistance system 1 calculates a free space around the vehicle F and then calculates permissible open positions, particularly opening angles, of the various vehicle doors T1, T2, T3, T4 within the free space that has been determined.

If, by way of example, the vehicle driver of the vehicle F opens the driver's door T1, the locking unit 8 of the door assistance system 1 locks the vehicle door T1 concerned when same is opened to the correspondingly calculated maximum permissible open position of the vehicle door T1 in order to prevent contact with an external object or obstacle H1. This prevents door T1, when it is opened, striking obstacle H1 and, by way of example, causing paint damage or scratches on vehicle F or a vehicle H1 parked alongside. As can be seen from FIG. 2, the environmental data model in a possible embodiment relates to a rasterized map or a data grid. The resolution of the environmental data model can vary. In a possible embodiment, the resolution of the vehicle environment can be approximately 1 cm. The latched environmental data model represented schematically in FIG. 2 is determined by the evaluation unit 5 based on the sensor data and temporarily stored in the data memory 6 of the door assistance system 1. The calculation unit 7 evaluates the temporarily stored environmental data model and calculates maximum permissible positions or opening angles of the various vehicle doors T1 to T4. In a possible embodiment, to this end the calculation unit 7 also takes the vehicle data of the vehicle F stored in the second data memory 9 into consideration, particularly vehicle dimensions of the vehicle body, dimensions of the vehicle doors and of the vehicle opening panels of the vehicle F concerned.

FIG. 3 is a flow chart of a possible embodiment of the method according to the invention for preventing door damage to vehicle doors and/or vehicle opening panels caused by external objects on a vehicle F.

In a first step S1, a space around the vehicle F that is free of external objects O is determined on the basis of a detected environmental data model and stored vehicle data of the vehicle F. Then, in a further step S2, maximum permissible open positions of the various vehicle doors and/or vehicle opening panels of the vehicle F within the free space that has been determined are calculated. In a further step S3, a vehicle door and/or vehicle opening panel of the vehicle when same is opened is locked at the calculated maximum permissible open position of the respective vehicle door and/or vehicle opening panel in order to prevent contact with an external object O. The method represented in FIG. 3 can be performed by a control program on a microprocessor of the driver assistance system.

FIG. 4 shows a simple application example of the door assistance system 1 according to the invention. In the application example represented, a vehicle F is located in a garage G and a person opens a trunk panel or tailgate T5 of the vehicle, in order to load or unload items. In a possible embodiment, a stereo camera acting as vehicle sensor can supply camera images from which the ceiling height of the garage G is calculated, wherein this information is fed into the environmental data model. In a possible embodiment, the environmental data model also comprises ground clearance information and/or height information or a height profile. In this embodiment, the stored environmental data model has further layers, in which the height information data or the ground clearance information data are stored. This embodiment offers the advantage that, by way of example, in a parking facility the driver no longer has to be aware of whether the opened tailgate or trunk panel will strike the ceiling, since the tailgate or the trunk panel will be locked in due time by the door assistance system 1 according to the invention before it hits the ceiling of the parking garage. This is, by way of example, an advantage in parking facilities of furniture stores or similar, since the user no longer has to hold the tailgate or the trunk panel steady during loading. The function represented schematically in FIG. 4 is of particular advantage for, by way of example, SUVs, the trunk panels of which can easily strike the ceiling of parking garages.

FIG. 5 is a schematic representation of a further application of the door assistance system 1 according to the invention. In the example represented, the vehicle F is parked on uneven ground. Here the door assistance system 1 has an environmental data model of the vehicle environment of the vehicle, which includes a height profile of the vehicle environment detected by sensors. When a side door is opened, this allows the door to be prevented from striking an uneven surface, by way of example a curbstone or similar.

FIG. 6, again schematically, represents the functioning of the door assistance system 1 according to the invention. When opening a door T, the door assistance system 1 according to the invention prevents door T striking an external object O, by locking door T at the calculated maximum permissible open position. The door T has a support S on the inside, which can be used by a person as entry or exist assistance. Entry or exit assistance can also be provided by the door assistance system 1 according to the invention, if the vehicle F is located on open ground and there are no external objects present in the environment of the vehicle. In a possible embodiment of the door assistance system 1 according to the invention, the open position of the door T is calculated so that the support S of the door provides the most effective support for an entering or exiting person, by way of example an elderly person. The door assistance system 1 in this embodiment offers active entry or exit assistance for a person, particularly elderly persons.

1. A door assistance system (1) for a vehicle (F) for preventing door damage to vehicle doors (T1-T4) and/or vehicle opening panels (T5) caused by external objects when vehicle doors (T1-T4) and/or vehicle opening panels (T5) are opened, having:
a calculation unit (7), which evaluates an environmental data model, detected by sensors, of the surroundings of the vehicle (F), in order to determine a space around the vehicle (F) that is free from external objects (H1, H2, O) and which calculates maximum permissible open positions of the various vehicle doors (Tl-T4) and/or vehicle opening panels (T5) of the vehicle (F) within the free space that has been determined
and having
a locking unit (8), which locks a vehicle door (T1-T4) and/or vehicle opening panel (T5) of the vehicle (F) when same is opened to the correspondingly calculated maximum permissible open position of the respective vehicle door (T1-T4) and/or vehicle opening panel (T5) in order to prevent contact with an external object and/or to provide entry or exit assistance.

2. The door assistance system according to claim 1, wherein the environmental data model comprises a rasterized map of the vehicle environment and/or a height profile of the vehicle environment.

3. The door assistance system according to claim 1, wherein the environmental data model is calculated based on sensor data, generated by vehicle sensors (2, 3, 4) of the vehicle (F) or by external sensors.

4. The door assistance system according to claim 3, wherein the vehicle sensors (2, 3, 4) comprise laser scanners, radar sensors and/or vehicle cameras.

5. The door assistance system according to claim 1, wherein a current environmental data model of the vehicle environment of the vehicle (F) is temporarily stored in a data memory (6), to which the calculation unit (7) of the door assistance system (1) has access.

6. The door assistance system according to claim 5, wherein the calculation unit (7) has access to a second data memory (9), in which the vehicle data of the vehicle (F), particularly vehicle dimensions of the vehicle body and/or dimensions of vehicle doors and/or vehicle opening panels of the vehicle (F), are stored.

7. The door assistance system according to claim 6, wherein the vehicle data of the vehicle (F) stored in the second data memory (9) are configurable for various vehicle types and/or vehicle variants of the vehicle (F).

8. The door assistance system according to claim 1, wherein the calculation unit (7) calculates the maximum permissible open positions of the vehicle doors (T1-T4) and/or vehicle opening panels (T5) of the vehicle (F) as a function of an instantaneous loading state of the vehicle (F) detected by sensors.

9. The door assistance system according to claim 1, wherein the door assistance system (1) is activated automatically upon entering a parking space or once the vehicle (F) has stopped.

10. The door assistance system according to claim 1, wherein the door assistance system (1) is automatically deactivated once the vehicle (F) starts up or upon leaving a parking facility or parking space.

11. The door assistance system according to claim 1, wherein the vehicle doors (T1-T4) comprise several side doors of the vehicle (F) and the vehicle opening panels (T5) comprise a tailgate, a trunk panel, or an engine compartment lid of the vehicle (F).

12. A road vehicle, having a door assistance system (1) according to claim 1.

13. The vehicle according to claim 12, wherein the vehicle (F) is an automobile or a truck.

14. A parking facility with a central control system, which communicates via wireless interfaces with a door assistance system of a vehicle according to claim 1, and also transmits sensor data generated by sensors of the parking facility for updating the environmental data model to the door assistance system (1) of the vehicle (F) located in the parking facility, wherein the door assistance system (1) of the vehicle (F) located in the parking facility takes into consideration the received sensor data of the parking facility when updating the environmental data model of the vehicle (F).

15. A method for preventing door damage to vehicle doors and/or vehicle opening panels caused by external objects in a vehicle (F) having the following steps:
(a) determining (S1) a space around the vehicle (F) that is free of external objects on the basis of a detected environmental data model and stored vehicle data of the vehicle;
(b) calculating (S2) maximum permissible open positions of the various vehicle doors and/or vehicle opening panels of the vehicle (F) within the free space that has been determined; and
(c) locking (S3) a vehicle door and/or vehicle opening panel of the vehicle when same is opened to the calculated maximum permissible open position of the respective vehicle door and/or vehicle opening panel in order to prevent contact with an external object and exit assistance.

16. A driver assistance system for a vehicle with a control unit for performing the method according to claim 15.
